(19) United States
(12) Patent Application Publication
(10) Pub. No.: US 2002/0174437 A1
(43) Pub. Date: Nov. 21, 2002

(54) Method and apparatus for controlling image quality by culling transmitted image information

(76) Inventors: Satoko Mano, Kawasaki (JP); Katsuhito Sawada, Kawasaki (JP)

Correspondence Address: Rosenman & Colin LLP, 575 Madison Avenue, New York, NY, 10022-2585, US

(21) Appl. No.: 09/964,823

(22) Filed: Sep. 27, 2001

(30) Foreign Application Priority Data
May 16, 2001 (JP) 2001-146671

(51) Int. Cl. H04N 7/173

(52) U.S. Cl. 725/95; 709/219; 725/91; 725/86

(57) ABSTRACT

A method includes an acquiring step of acquiring a number indicative of how many picture frames are guaranteed in a predetermined time period, the number being determined according to at least one of a transmission source and a transmission destination of image information, a counting step of counting a number indicative of how many picture frames of the image information are transmitted to the transmission destination from the transmission source in the predetermined time period, and a transmitting step of culling the image information transmitted from the transmission source according to the number of the guaranteed picture frames and the number of the transmitted picture frames, and transmitting the culled image information to the transmission destination.

### BACKGROUND OF THE INVENTION

1. Field of the Invention

The present invention generally relates to quality control guarantee methods, quality control guarantee apparatuses, and network connection apparatuses. The present invention particularly relates to a quality control guarantee method, a quality control guarantee apparatus, and a network connection apparatus for distributing image information through a network.

2. Description of the Related Art

Conventional technologies for encoding and compressing video information include a Motion JPEG, for example. The Motion JPEG encodes and compresses moving pictures on a frame-by-frame basis.

In recent years, image distribution apparatuses employing the Motion JPEG for distributing image information through networks such as LAN (Local Area Network) have been widely used. The image distribution apparatuses also serve as a WWW (World Wide Web) server, and distribute video information through networks by using HTTP (Hyper Text Transfer Protocol). Users enjoy the distributed image information by using a browser or the like of the user terminal.

Bandwidth control units are also widely used that guarantee QoS (Quality Of Service) of networks. The bandwidth control units control traffic by determining a maximum transmission bandwidth for each IP (Internet Protocol) address and URL (Uniform Resource Locator), for example, to guarantee QoS.

In the following, the guarantee of network QoS will be described with reference to FIG. 1 and FIG. 2. FIG. 1 shows a configuration of an example of an image distribution system. FIG. 2 shows an example of maximum transmission bandwidths provided in the bandwidth control unit.

Image distribution apparatus 101a receives image information supplied from a camera 100a, and carries out a compression coding of the supplied image information, for example, by the Motion JPEG, and transmits the compressed image information to a network 102. Further, image distribution apparatus 101b receives image information supplied from a camera 100b, and carries out the compression coding of the supplied image information, for example, by the motion JPEG, and transmits the compressed image information to the network 102.

The network 102 includes one or more bandwidth control units. In a bandwidth control unit, maximum transmission bandwidths defined by the maximum transmission volume per unit time (for example, 100 kbps and the like) are set up for each transmission source and each transmission destination, as shown in FIG. 2. For example, in FIG. 2, the bandwidths made available between the image distribution apparatus 101a and each of users A, B and C are defined as 1 Mbps for the user A 103a, 768 Kbps for the user B 103b, and 384 Kbps for the user C 103c, respectively. Accordingly, the amount of transmission of the image information to the user terminal 103a, for example, from the image distribution apparatus 101a is restricted to 1 Mbps or less by the bandwidth control unit.

In an image distribution system using the Motion JPEG, the larger the transmission bandwidth is, the more picture frames are transmitted, giving a user terminal high quality moving images. Conversely, the smaller the transmission bandwidth is, the fewer picture frames can be transmitted, giving the user terminal non-smooth motion pictures. Therefore, in an image distribution system using the Motion JPEG, the larger the transmission bandwidth is, the better the quality will be, and the smaller the transmission bandwidth is, the poorer the quality will be.

As above, the image information is transmitted via the network 102 to the user terminals 103a through 103c with the transmission volume controlled by the bandwidth control unit as required.

However, when the QoS guarantee is provided by defining the maximum transmission volume per unit time in a network for distributing image information by compression coding of the Motion JPEG, there have been following problems.

When the data volume of a given frame included in the image information is larger than the maximum transmission volume per unit time, all of the compression coded image information cannot be transmitted. Therefore, the image information of this frame will be partially lost, causing a problem that the image information cannot be reproduced.

Further, the data volume of the frame included in the image information varies from frame to frame depending on pictures. There will thus be a case where the number of frames actually passing through a network may not reach an expected number, depending on network conditions. This give rise to a problem that a sufficient video performance may not be attained.

Furthermore, since the data volume of the frame included in the image information varies from frame to frame depending upon pictures, the number of frames per unit time is not certain, and varies irregularly depending on network conditions. This will cause an unrealistic video appearance when presented to users.

As described above, it is highly difficult to control the QoS guarantee based on the maximum transmission volume per unit time.

### SUMMARY OF THE INVENTION

It is an object of the present invention to provide a quality control guarantee method, quality control guarantee apparatus, and network connection apparatus that substantially obviate one or more of the problems caused by the limitations and disadvantages of the related art.

It is another and more specific object of the present invention to provide a quality control guarantee method, quality control guarantee apparatus and network connection apparatus for an easy quality control guarantee management, allowing a communication quality control guarantee that is not influenced by network conditions or data volume of image information.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a quality control guarantee method, quality control guarantee apparatus, and network connection apparatus, particularly pointed out in the specification in such full, clear, concise, and exact terms as to enable a person having ordinary skill in the art to practice the invention.

To achieve these and other advantages and in accordance with the object of the invention, as embodied and broadly described herein, the invention provides a method, including acquiring the number of guaranteed picture frames in every predetermined time, the number being set up corresponding to at least one of a transmission source and a transmission destination of image information, counting the number of receiving picture frames in every predetermined time of the image information transmitted from the transmission source to the transmission destination, culling the image information transmitted from the transmission source according to the number of the guaranteed picture frames and the number of the receiving picture frames, and transmitting the culled image information as described above to the transmission destination.

In the present invention, the maximum transmission bandwidth is defined as the number of picture frames in every predetermined time period, so that the maximum data volume of the image information transmitted from a transmission source to a transmission destination can be restricted in terms of the number of picture frames in every predetermined time period.

Since the maximum transmission bandwidth is defined in terms of the number of picture frames, the image information can be reproduced without being influenced by the data volume of the image information or network conditions. Further, it is possible to avoid transmission of image information that will not be reproducible at the transmission destination due to the partial loss of image information, thereby make an efficient use of the transmission bandwidth.

Furthermore, defining the maximum transmission bandwidth in terms of the number of guaranteed picture frames in every unit time makes it possible to manage the maximum transmission bandwidth in such a manner as to allow an intuitive grasp, facilitating the management of a quality control guarantee.

### BRIEF DESCRIPTION OF DRAWINGS

FIG. 1 is a configuration drawing of an example of an image distribution system;

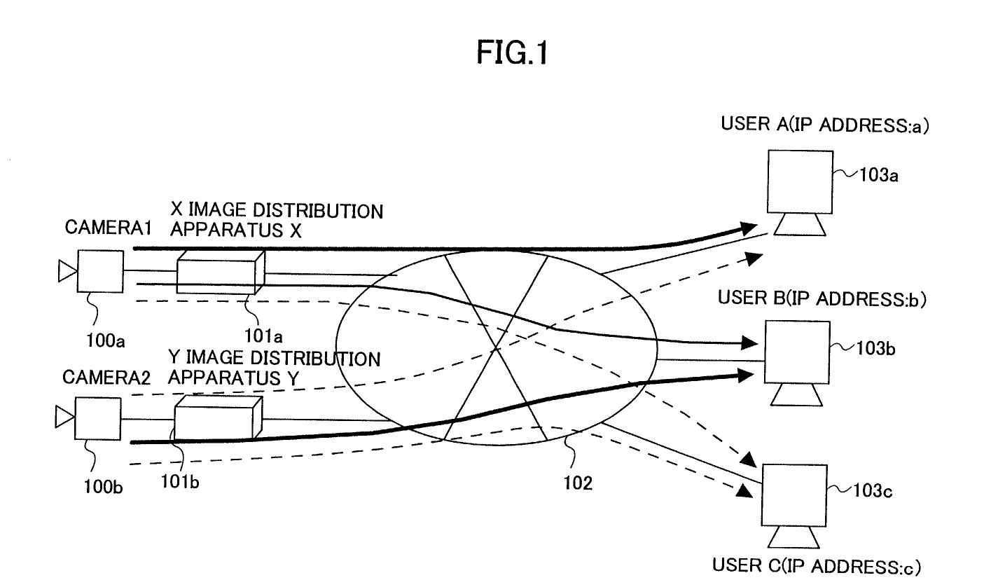

FIG. 2 describes an example of the maximum transmission bandwidth set up in a bandwidth control unit;

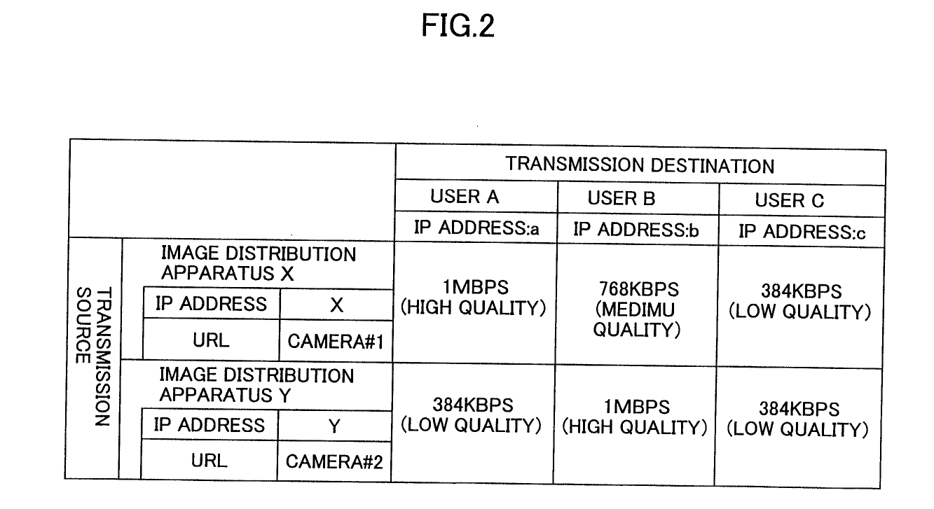

FIG. 3 is a configuration drawing of an example of an image distribution system of the present invention;

FIG. 4 describes an example of the number of guaranteed picture frames set up in a bandwidth control unit;

FIG. 5 is a configuration drawing of an example of an HTTP header;

FIG. 6 is a sequence drawing of an example of an image distribution system;

FIG. 7 describes an example of relations between image information and IP packet;

FIG. 8 is a configuration drawing of an embodiment of the bandwidth control unit of the present invention;

FIG. 9 is a configuration drawing of an example of User management DB;

FIG. 10 is a configuration drawing of an example of distribution demand management DB.

FIG. 11 is a flowchart of an example of a bandwidth control unit;

FIG. 12 is a configuration drawing of other examples of the image distribution system by the present invention; and

FIG. 13 describes an example of User management DB which is included in a bandwidth control unit.

### DESCRIPTION OF THE PREFERRED EMBODIMENTS

In the following, embodiments of the present invention will be described with reference to drawings. Although the embodiments are described as using the Motion JPEG as an example of a compression coding method, any compression coding method may be used. Further, although cases that use a LAN as an example of a network is described, any network is applicable such as the Internet and the like.

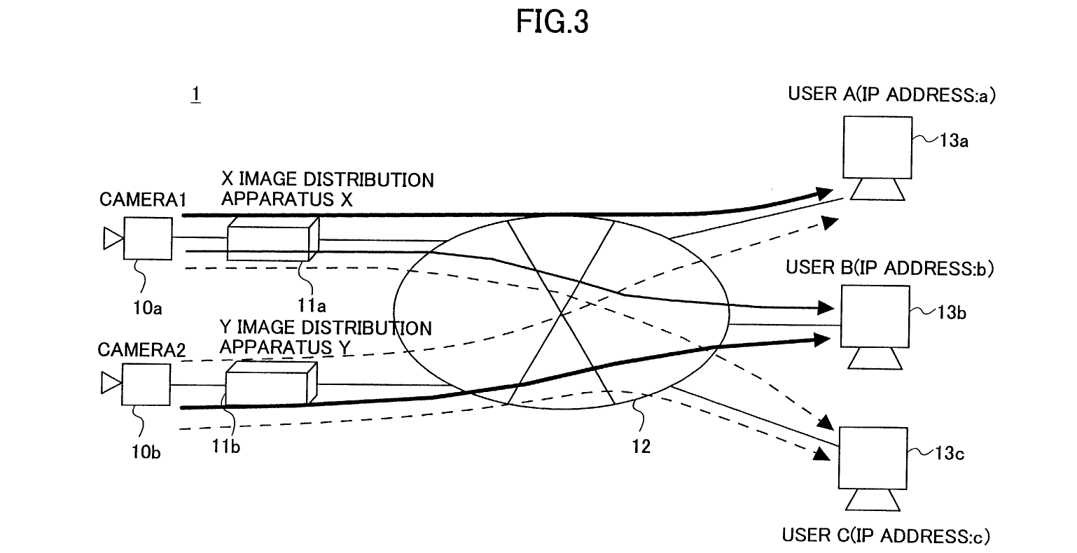

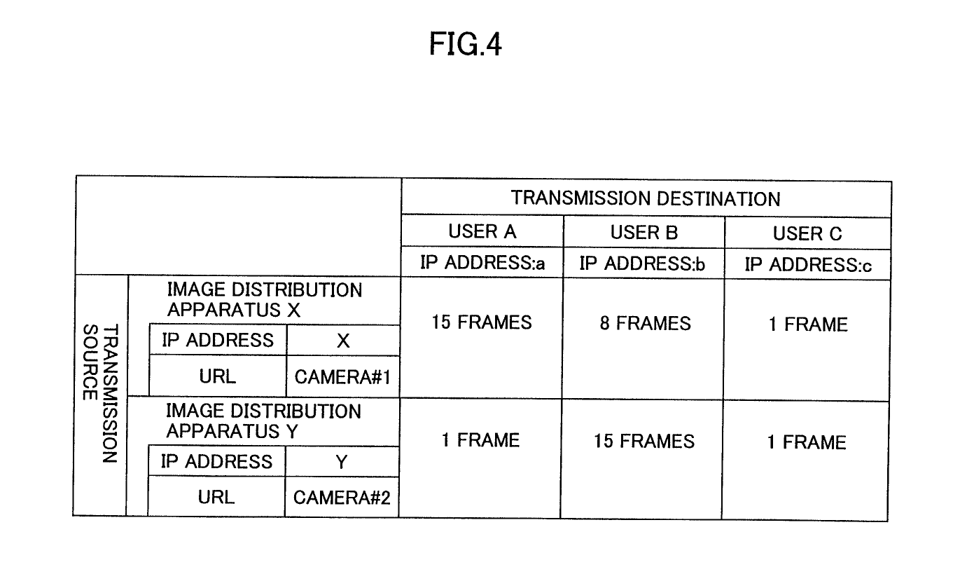

First, the principle of the present invention will be described with reference to FIG. 3 and FIG. 4 in order to facilitate an understanding of the present invention. FIG. 3 is the configuration drawing of an example of the image distribution system of the present invention. FIG. 4 describes an example of the number of guaranteed picture frames set up in a bandwidth control unit.

Image distribution apparatus 11a receives image information (video) supplied from a camera 10a, and carries out a compression coding of the supplied image information by the Motion JPEG, and transmits the coded information to a network 12. Further, image distribution apparatus 11b receives image information (video) supplied from a camera 10b, and carries out the compression coding of the supplied image information by the Motion JPEG, and transmits the coded information to the network 12.

The network 12 includes one or more bandwidth control units. In the bandwidth control unit, the maximum transmission bandwidth corresponding to a transmission source and a transmission destination is set up in terms of the maximum number of transmission picture frames in unit time (called “number of guaranteed frames”hereunder). In FIG. 4, one picture frame corresponds to one frame of the image information of the compression coding carried out by the Motion JPEG.

For example, in FIG. 4, the guaranteed numbers of picture frames for the image distribution from image distribution apparatus 11a are set up as 15 frames to a user terminal 13a, 8 frames to a user terminal 13b, and one frame for a user terminal 13c, respectively. Further, the number of the guaranteed picture frames for distribution from the image distribution apparatus 11b are set up as one frame to the user terminal 13a, 15 frames to the user terminal 13b, and one frame to the user terminal 13c, respectively.

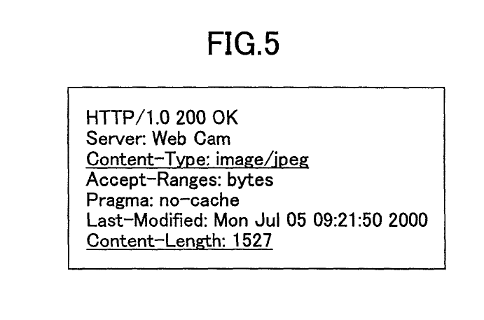

When distributing the image information to the network 12 by HTTP, the image distribution apparatus 11a and 11b transmit the image information which includes an HTTP header as shown in FIG. 5 to the network 12 in response to transmission demands (Get) from the user terminals 13a through 13c.

The bandwidth control unit acquires a type of a compression method and data length of a picture frame, referring to the content type (Content-Type) and content length (Content-Length) which are included in the HTTP header as shown in FIG. 5. For example, the content type indicates that the Motion JPEG is used and the content length of the HTTP header indicates there are 1527 bytes in the case of FIG. 5.

The bandwidth control unit counts the number of picture frames received in unit time (called “number of receiving frames” hereunder), using the data length information acquired from the content length information. For example, in the case of the content length of FIG. 5, the bandwidth control unit determines that one frame has been received by receiving 1527 bytes.

The bandwidth control unit compares the number of receiving frames with the number of guaranteed picture frames. If the number of receiving frames is larger than the number of guaranteed picture frames, frames are dropped such that the number of receiving frames becomes equal to or less than the number of guaranteed picture frames. Accordingly, the transmission amount of the image information from the image distribution apparatus 11a to the user terminal 13a, for example, is restricted to 15 or less frames by the bandwidth control unit.

In an image distribution system employing the Motion JPEG, the larger the transmission bandwidth is, the more frames are transmitted, giving better quality moving pictures. Conversely, if the transmission bandwidth is small, only a small number of frames will be transmitted, providing less smooth motion pictures. Therefore, in the image distribution system using the Motion JPEG, the larger the number of guaranteed picture frames is, the higher the quality will be, and vice versa.

The image information controlled according to the respective number of guaranteed picture frames is transmitted to the user terminals 13a through 13c from the network 12.

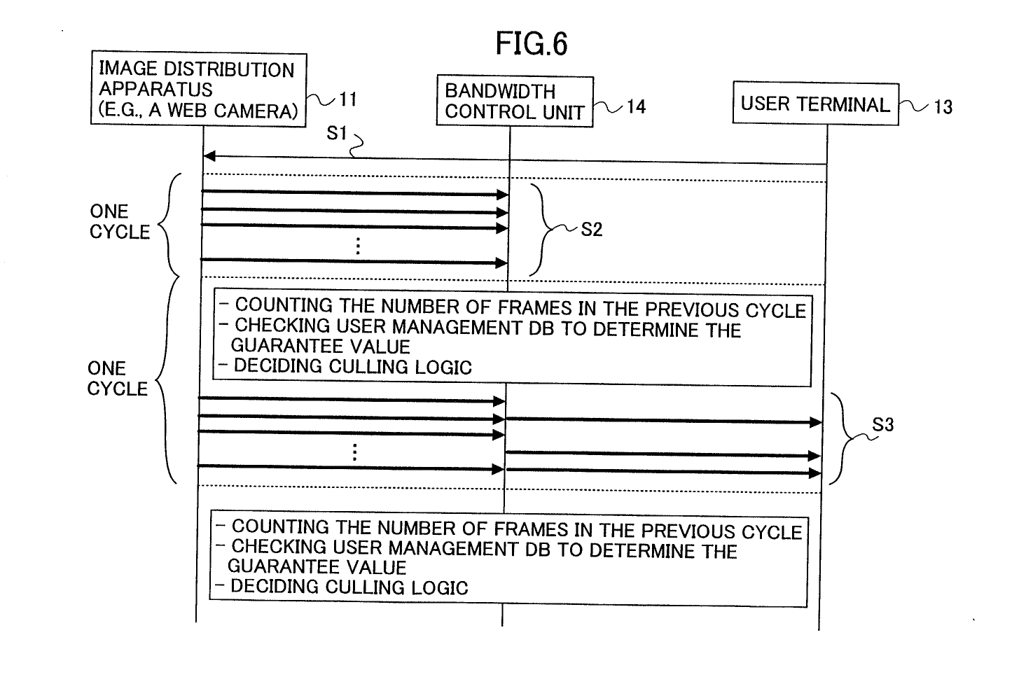

FIG. 6 shows an example of an operation sequence in an image distribution system. In FIG. 6, a user terminal 13 issues an image distribution demand to the image distribution apparatus 11 at a step S1. In a step S2 following the step S1, the image distribution apparatus 11 carries out the compression coding (encoding) of the analog picture signals, such as an NTSC signal supplied from a camera and the like by Motion JPEG, and generates IP packets of the image information at a rate of 30 frames per second, for example, to transmit to the network. In addition, the image distribution apparatus 11 continues transmitting image information until an image distribution stop demand is supplied.

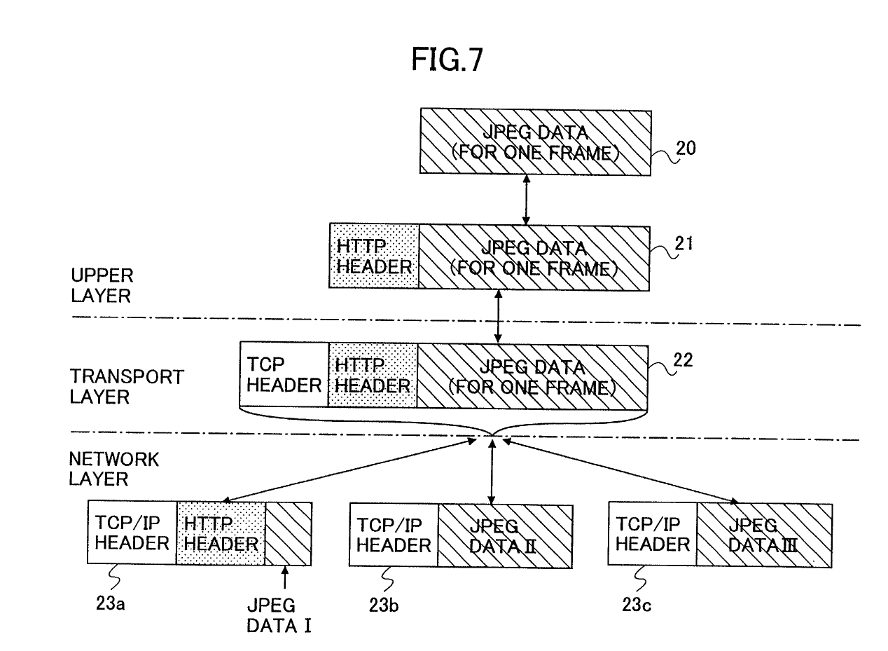

Here, the relation between the image information and the IP packet is described, referring to FIG. 7. FIG. 7 shows an example to describe the relation between the image information and the IP packet. The JPEG data 20 in FIG. 7 is equivalent to the image information corresponding to one frame.

For example, the image distribution apparatus 11 generates a packet 21 by adding an HTTP header to the JPEG data 20, and generates a packet 22 by further adding a TCP header to the packet 21. The image distribution apparatus 11 will divide the packet 22 into a number of packets of suitable length, if the data-gram (TCP header +HTTP header +JPEG data) length of the packet 22 is larger than the packet length that the network allows. And the image distribution apparatus 11 adds an IP header to the packet 22, or the packet 22 divided into a number of packets of suitable length.

For example, FIG. 7 shows a case in which the packet 22 is divided into three packets, an IP header is added to each of the three packets 23a through 23c. Here, the JPEG data I of the IP packet 23a, the JPEG data II of the IP packet 23b, and the JPEG data III of the IP packet 23c jointly make up the JPEG data 20. In other words, the three packets assembled are equivalent to the image information for one frame.

The bandwidth control unit 14 receives the IP packets 23a through 23c transmitted from the image distribution apparatus 11, and reproduces the JPEG data 20 in a procedure reverse to generating the IP packets 23a through 23c from the JPEG data 20 in the image distribution apparatus 11.

For example, the bandwidth control unit 14 generates the packet 22 by assembling a data-gram, while deleting the IP header from the IP packets 23a through 23c that were received. Further, the bandwidth control unit 14 generates the packet 21 by deleting the TCP header of the packet 22. The bandwidth control unit 14 generates the JPEG data 20 according to the content length in the HTTP header.

The bandwidth control unit 14 can acquire the number of receiving frames by counting the number of pieces of the generated JPEG data 20 in every cycle (for example, for 1 second). It is desirable that the JPEG data received in the first one cycle is not distributed to a user terminal. Here, the cycle means the unit time of the number of guaranteed picture frames.

The bandwidth control unit 14 acquires the number of guaranteed picture frames set up for each transmission source and transmission destination from a database (called DB henceforth), and determines frame culling processes so that the number of receiving frames becomes equal to or smaller than the number of guaranteed picture frames. The process will be determined according to the result of the following formula (1).

X=(number of receiving frames)/(the number of guaranteed picture frames) (1)

Where, for example, X<=1, the bandwidth control unit 14 does not cull, judging that the number of receiving frames is not over the number of guaranteed picture frames. If X>1, the bandwidth control unit 14 judges that the number of receiving frames is over the number of guaranteed picture frames, and omits below the decimal point of X, and culls out X−1 receiving frames in every X frames. In addition, the frame culling of receiving frames shall be performed evenly in order to lessen incongruity felt by a user.

In a step S3 following the step S2, the bandwidth control unit 14 converts the JPEG data 20 after culling, into an IP packet as shown in FIG. 7, and transmits the IP packet to the user terminal 13. The user terminal 13 receives the IP packet transmitted from the bandwidth control unit 14, and reproduces the JPEG data 20 from the IP packets 23a through 23c as shown in FIG. 7.

The user terminal 13 displays the JPEG data on a screen using software, such as a general-purpose browser. Perception level of incongruity is remarkably lowered when viewing the video displayed on the user terminal 13 since a suitable culling has been performed by the bandwidth control unit 14. Therefore, the image distribution system 1 can offer a communication quality control guarantee, without being influenced by the data volume of the image information, or the network status.

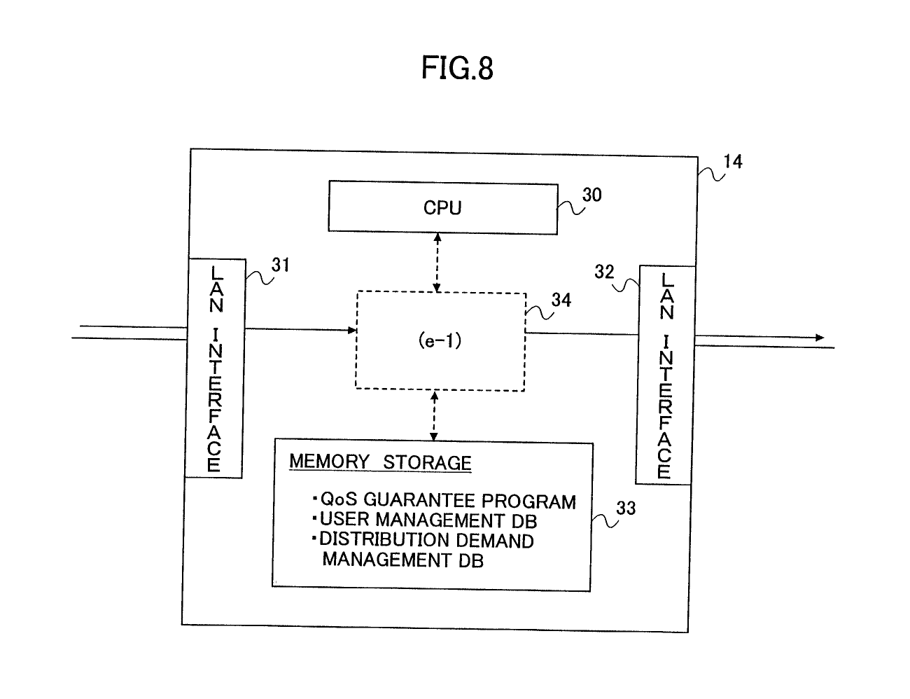

FIG. 8 shows configuration of an embodiment of the bandwidth control unit of the present invention. The bandwidth control unit 14 of FIG. 8 includes a CPU (Central Processing Unit) 30, LAN interfaces 31 and 32, a memory storage 33, and memory apparatus 34 The LAN interface 31 is an interface for connecting the bandwidth control unit 14 to a network, such as LAN, and receives an IP packet, for example, from the network. Further, the LAN interface 32 is an interface for connecting the bandwidth control unit 14 to a network, such as LAN, and transmits an IP packet, for example, to the network.

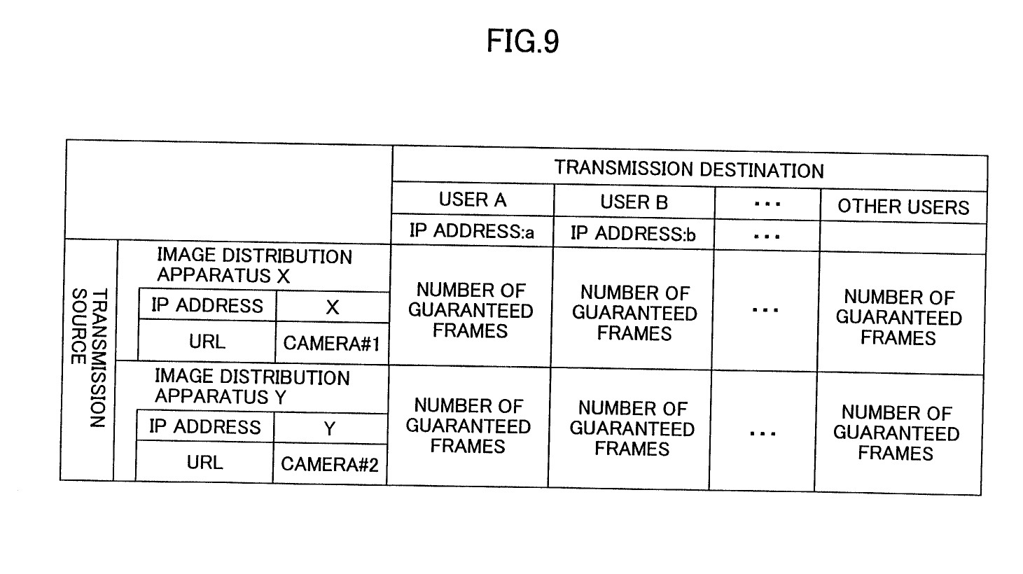

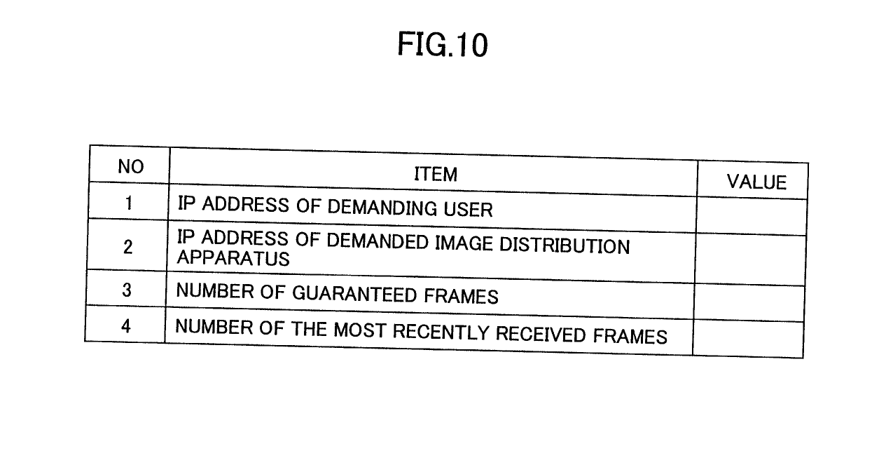

The memory storage 33 stores QoS guarantee program for executing the quality control guarantee method of the present invention, a user management DB as shown in FIG. 9, a distribution demand management DB as shown in FIG. 10, and the like.

FIG. 9 shows configuration of an example of the user management DB. Further, FIG. 10 shows configuration of an example of the distribution demand management DB. The user management DB in FIG. 9 stores information about users of the image distribution system 1, wherein the number of guaranteed picture frames for each transmission source and transmission destination is set up. In addition, the number of guaranteed picture frames to non-registered users (henceforth other users) is also set up in the user management DB.

The distribution demand management DB in FIG. 10 stores data for setting up a culling process, which includes an IP address of a demanding user, an IP address of demanded image distribution apparatus, the number of guaranteed picture frames, and the latest number of receiving frames.

The memory apparatus 34 reads and stores a QoS guarantee program from the memory storage 33, for example, at starting the bandwidth control unit 14. The CPU 30 performs processing which relates to the bandwidth control unit 14 according to the QoS guarantee program that has been read and stored in the memory apparatus 34.

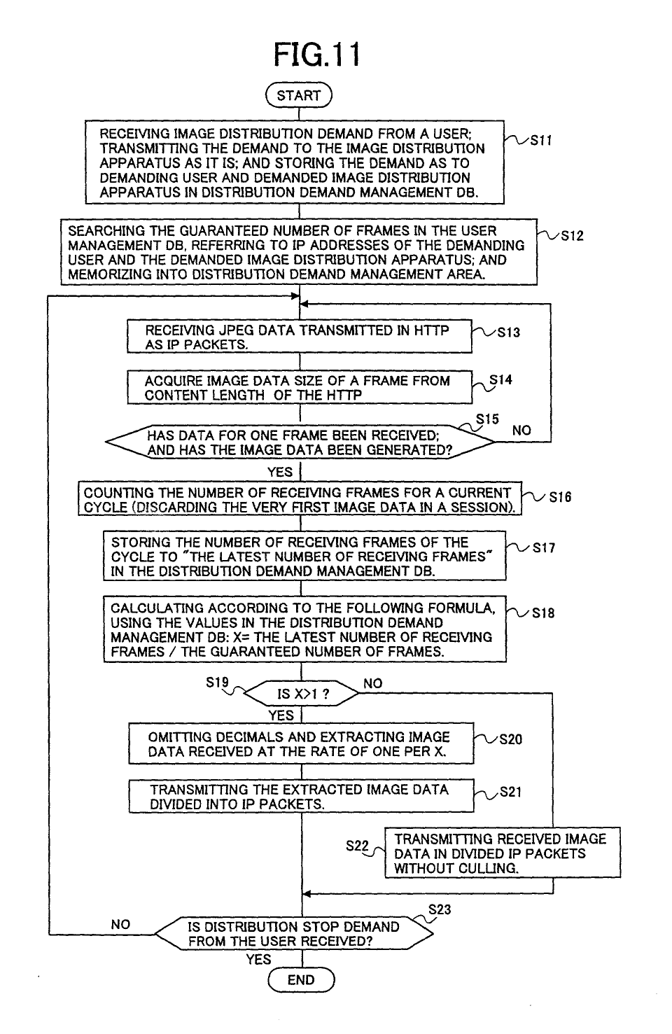

FIG. 11 is a flowchart of an example of a bandwidth control unit. At a step S11 in FIG. 11, the CPU 30 receives an image distribution demand from a user terminal. From the image distribution demand received, the CPU 30 reads IP addresses of the demanding user and demanded image distribution apparatus, and stores the IP addresses of the demanding user and the demanded image distribution apparatus in the distribution demand management DB. And the CPU 30 transmits the image distribution demand to the image distribution apparatus as it was received.

In a step S12 following the step S11, the CPU 30 searches the user management DB for a number of guaranteed picture frames with the IP addresses of the demanding user and the demanded image distribution apparatus as a key, and stores the searched number of guaranteed picture frames into the distribution demand management DB.

In a step S13 following the step S12, the CPU 30 receives an IP packet through the LAN interface 31. In a step S14, as described above in reference with FIG. 7, the CPU 30 generates a packet that includes an HTTP header from the IP packet, and acquires the content length of the HTTP. The CPU 30 acquires the data length (image information size) of a frame from the content length of the acquired HTTP.

In a step S15 following the step S14, the CPU 30 determines whether the JPEG data generated from IP packets reached the data length of the frame. If it determines that the JPEG data generated from the IP packets has reached the data length of the frame (that is, YES in S15), the CPU 30 will progress to a step S16. If it determines that the JPEG data generated from the IP packets has not reached the data length of the frame (that is, NO in S15), the CPU 30 will repeat processing of the steps S13 through S15.

In the step S16, the number of receiving frames is acquired by counting the number of the pieces of the generated JPEG data in one cycle. Here, JPEG data received in the first one cycle may be discarded without distributing to a user terminal. And in a step S17 following the step S16, the CPU 30 stores the acquired number of receiving frames into the distribution demand management DB.

In a step S18 following the step S17, the CPU 30 calculates according to the formula (1), using the number of guaranteed picture frames and the latest number of receiving frames, which are stored in the distribution demand management DB. In a step S19 following the step S18, the CPU 30 determines whether the calculation result of the formula (1) gives X>1.

If it determines that the calculation result of the formula (1) was X>1 (that is, YES in S19), it progresses to a step S20 wherein the CPU 30 determines that the number of receiving frames exceeds the number of guaranteed frames, omits decimals of X, and extracts a receiving frame every X frames.

In a step S21 following the step S20, the CPU 30 converts the JPEG data corresponding to the receiving frame extracted at the step S20 into IP packets, and transmits the IP packets to the network through the LAN interface 32.

In addition, if it determines that the calculation result of the formula (1) was not X>1 (that is NO in S19), it will progress to a step S22 and the CPU 30 will not cull any frames out, having determined that the number of receiving frames was not over the number of guaranteed picture frames. And the CPU 30 converts the JPEG data corresponding to a receiving frame into IP packets, and transmits the IP packets to the network through the LAN interface 32.

In a step S23 following the step S21 or S22, the CPU 30 determines whether it has received the image distribution stop demand from the user. If it determines that the image distribution stop demand from the user is received (that is, YES in S23), the CPU 30 will end processing. Further, if it determines that it has not received the image distribution stop demand from the user (that is, NO in S23), the CPU 30 will progress to the step S13, and will continue processing.

Therefore, since the bandwidth control unit 14 can provide a QoS guarantee according to the number of guaranteed picture frames, which is stored in the user management DB, the QoS guarantee that is not influenced by the data volume of the image information or the network status can be realized.

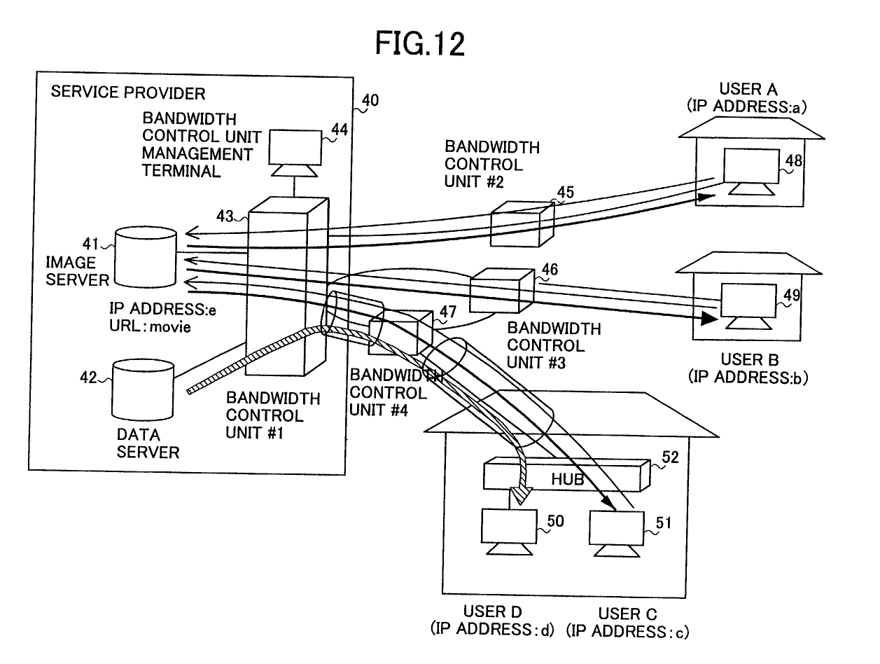

FIG. 12 shows another embodiment of the image distribution system of the present invention. The image distribution system of FIG. 12 represents a case wherein a service provider 40 distributes video (motion JPEG image) using FTTH (Fiber To The Home) and the like.

The service provider 40 distributes a motion JPEG image or data according to demands from user terminals 48 through 51. The service provider 40 can provide the QoS guarantee of the motion JPEG image also at network congestion by using the bandwidth control units 43, 45 through 47 of the present invention.

For example, even if a Motion JPEG image transmitted from the image server 41 to the user terminal 51 is supplied to the bandwidth control unit 47 simultaneously with data from the data server 42 to the user terminal 50, causing a network congestion, the number of the Motion JPEG image frames from the image server 41 to the user terminal 51 is guaranteed. Accordingly, the user C can enjoy the JPEG image without recognizing the network congestion.

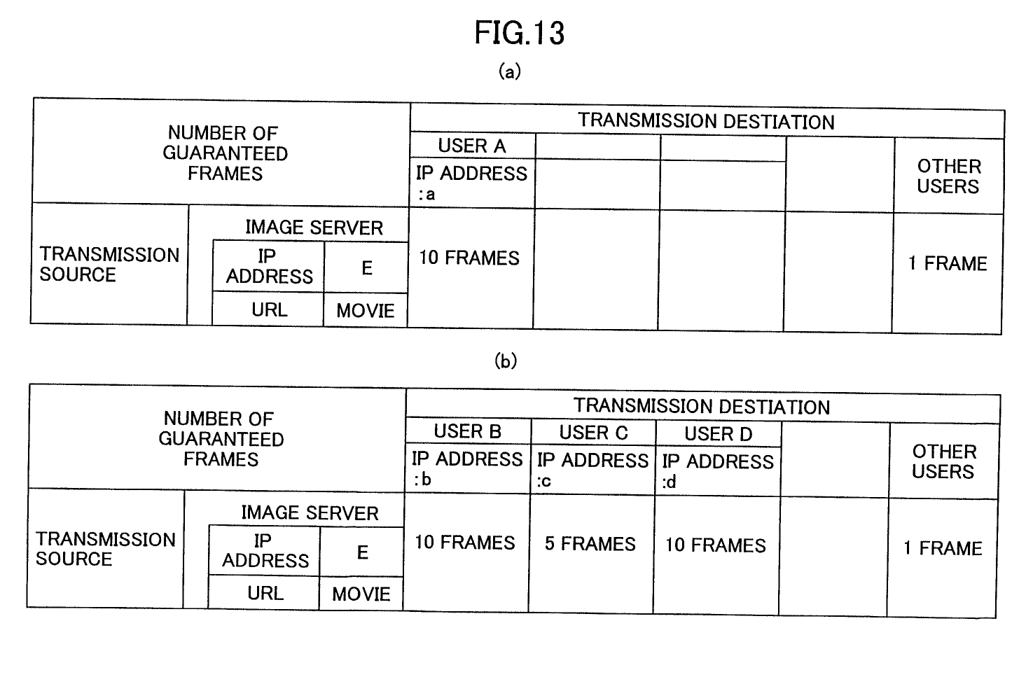

The bandwidth control unit 45 is provided with a user management DB as shown in FIG. 13(a), for example. The bandwidth control units 43, 46, and 47 are provided with a user management DB as shown in FIG. 13(b), for example. The bandwidth control unit 45 serves only a user A, and the guaranteed numbers of picture frames of the user A and other users are set, respectively, as shown in FIG. 13(a)

The bandwidth control units 43, 46, and 47 make up a trunk loop. In view of a routing change by the spanning protocol when a transmission path fault occurs in the loop, it is desirable that each bandwidth control unit is provided with the guaranteed numbers of picture frames of all the users in the loop.

A service can be continued to a user at a fault in a transmission path by setting the number of guaranteed picture frames for users B, C, and D, and other users in the loop in the user management DB of the bandwidth control units 43, 46, and 47, as shown in FIG. 13(b).

In addition, a central management of the DB of the bandwidth control units 43, 45 through 47 by a bandwidth control unit management terminal 44 can be devised. Further, since multicasting can be applied when distributing to users, it is desirable that the bandwidth control unit is capable of multicasting.

Although the embodiments of the present invention have been described around the examples that use a bandwidth control unit as the network connection apparatus, such as a router (Router) and a hub (Hub) can provide functions as shown in FIG. 8. Further, a network interface function and a QoS guarantee program can be installed in a general-purpose computer to realize the network connection apparatus.

Further, the present invention is not limited to these embodiments, but various variations and modifications may be made without departing from the scope of the present invention.

The present application is based on Japanese priority application No. 2001-146671 filed on May 16, 2001, with the Japanese Patent Office, the entire contents of which are hereby incorporated by reference.

What is claimed is:

1. A method, comprising:
an acquiring step of acquiring a number indicative of how many picture frames are guaranteed in a predetermined time period, the number being determined according to at least one of a transmission source and a transmission destination of image information;
a counting step of counting a number indicative of how many picture frames of the image information are transmitted to the transmission destination from the transmission source in the predetermined time period; and
a transmitting step of culling the image information transmitted from the transmission source according to the number of the guaranteed picture frames and the number of the transmitted picture frames, and transmitting the culled image information to the transmission destination.

2. The method as claimed in claim 1, wherein the transmitting step transmits the culled image information if the number of the transmitted picture frames is larger than the number of the guaranteed picture frames, and transmits the image information without culling if the number of the transmitted picture frames is not larger than the number of the guaranteed picture frames.

3. The method as claimed in claim 1, wherein the image information is encoded for every frame of the image information.

4. An apparatus, comprising a unit configured to acquire a number indicative of how many picture frames are guaranteed in a predetermined time period, the number being determined according to at least one of a transmission source and a transmission destination of image information, to count a number indicative of how many picture frames of the image information are transmitted to the transmission destination from the transmission source in the predetermined time period, to cull the image information transmitted from the transmission source according to the number of the guaranteed picture frames and the number of the transmitted picture frames, and to transmit the culled image information to the transmission destination.

5. The apparatus as claimed in claim 4, wherein said unit transmits the culled image information if the number of the transmitted picture frames is larger than the number of the guaranteed picture frames, and transmits the image information without culling if the number of the transmitted picture frames is not larger than the number of the guaranteed picture frames.

6. The apparatus as claimed in claim 4, wherein the image information is encoded for every frame of the image information.

7. An apparatus which connects a plurality of networks, comprising:
a first unit which receives image information from a first network;
a second unit which transmits the image information to a second network;
a third unit which stores a number indicative of how many picture frames are guaranteed in a predetermined time period, the number being determined according to at least one of a transmission source and a transmission destination of image information;
a fourth unit which stores a number indicative of how many picture frames of the image information are transmitted to the transmission destination from the transmission source in the predetermined time period; and
a fifth unit which counts the number of the transmitted picture frames of the image information transmitted from the transmission source to the transmission destination to store the number of the transmitted picture frames in the fourth unit, and culling the image information transmitted from the first network according to the number of the guaranteed picture frames and the number of the transmitted picture frames to transmit the culled image information to the second network.

8. The apparatus as claimed in claim 7, wherein the image information is encoded for every frame of the image information.
